(19) United States
(12) Patent Application Publication
(10) Pub. No.: US 2017/0151733 A1
(43) Pub. Date: Jun. 1, 2017

(54) METHOD OF 4D PRINTING A HYDROGEL COMPOSITE STRUCTURE

(71) Applicant: President and Fellows of Harvard College, Cambridge, MA (US)

(72) Inventors: Jennifer A. Lewis, Cambridge, MA (US); Amelia Sydney Gladman, Cambridge, MA (US)

(21) Appl. No.: 14/954,228

(22) Filed: Nov. 30, 2015

(51) Int. Cl. B29C 71/00; B33Y 10/00; B29C 67/00

(52) U.S. Cl. CPC B29C 71/0009; B29C 67/007; B33Y 10/00; B29K 2033/26

(57) ABSTRACT

A method of 4D printing a hydrogel composite structure comprises depositing a first layer of filaments on a substrate in a first predetermined arrangement, where each filament comprises a hydrogel matrix and a plurality of anisotropic filler particles embedded therein. A second layer of the filaments is deposited in a second predetermined arrangement on the first layer. The filaments from the second layer contact the filaments from the first layer at a number of contact regions. The first layer and the second layer are hydrated, and the filaments of the first and second layers swell in size while remaining in contact at the contact regions. Thus, a curved three-dimensional hydrogel composite structure is formed.

### FEDERALLY FUNDED RESEARCH OR DEVELOPMENT

This invention was made with government support under contract number W911NF-13-1-0489 awarded by the U.S. Army Research Office (ARO). The government has certain rights in the invention.

### TECHNICAL FIELD

The present disclosure is related generally to ink formulations for 3D printing and more particularly to printed structures that can swell to adopt a curved shape.

### BACKGROUND

3D printing entails flowing a rheologically-tailored ink composition through a deposition nozzle integrated with a moveable micropositioner having x-, y-, and z-direction capability. As the nozzle is moved, a filament comprising the ink composition may be extruded through the nozzle and continuously deposited on a substrate in a configuration or pattern that depends on the motion of the micropositioner. In this way, 3D printing may be employed to build up 3D structures layer by layer.

Shape morphing systems form the basis for a range of applications, such as smart textiles, autonomous robotics, biomedical devices, drug delivery and tissue engineering. Their natural analogues are exemplified by nastic plant motions, where a variety of organs such as tendrils, brachts, leaves and flowers respond to environmental stimuli (e.g., humidity, light, touch) by varying internal turgor that leads to dynamic conformations governed by tissue composition and microstructural anisotropy of cell walls. Plants exhibit hydration-trigged changes in their morphology due to differences in local swelling behaviour that arise from the directional orientation of stiff cellulose fibrils within plant cell walls.

### BRIEF SUMMARY

A method of 4D printing a hydrogel composite structure comprises depositing a first layer of filaments on a substrate in a first predetermined arrangement, where each filament comprises a hydrogel and a plurality of anisotropic filler particles embedded therein. A second layer of the filaments is deposited in a second predetermined arrangement on the first layer. The filaments from the second layer contact the filaments from the first layer at a number of contact regions. The first layer and the second layer are hydrated, and the filaments of the first and second layers swell in size while remaining in contact at the contact regions. Thus, a curved, three-dimensional hydrogel composite structure is formed.

The terms “comprising,” “including,” and “having” are used interchangeably throughout this disclosure as open-ended terms to refer to the recited elements (or steps) without excluding unrecited elements (or steps).

### BRIEF DESCRIPTION OF THE DRAWINGS

FIG. 1 is a schematic of the shear-induced alignment of anisotropic filler partiles in a hydrogel composite filament during extrusion of an ink formulation through a nozzle (direct ink writing).

FIG. 2A shows a 3D printed planar bilayer structure comprising hydrogel composite filaments prior to hydration; and FIG. 2B shows a hydrogel composite structure formed after exposing the bilayer structure of FIG. 2A to water.

FIG. 3 is a schematic of a portion of a hydrogel composite filament before (left image) and after (right image) swelling, where the anisotropy in the swelling along the long axis compared to the short axis is illustrated.

FIG. 4 is a plot showing the effect of nozzle diameter on transverse and longitudinal swelling behavior of printed hydrogel composite filaments.

FIG. 5 is a plot comparing the swelling strain of cast and printed samples formed with a nozzle diameter of 510 microns.

FIGS. 6A-6C show direct images of stained cellulose fibrils in isotropic (cast), unidirectional (printed) and patterned (printed) samples, respectively, where the scale bar represents 200 microns.

FIG. 6D shows data obtained from Fourier analysis of the stained images to quantify the directionality; printed unidirectional samples exhibit a clear peak corresponding to the print direction, while isotropic samples show no clear directional peaks.

FIGS. 7A-7D show images of a 4D printed structure (90°/0° bilayer) including a stimuli-responsive hydrogel (poly(N-isopropylacrylamide; PNIPAm)) containing oriented cellulose fibrils that reversibly changes shape depending on the water temperature; FIGS. 7A and 7B show respective top and side views of the hydrated structure at room temperature and FIGS. 7C and 7D show respective top and side views of the planar structure obtained after exposing the hydrated structure to a warm water bath. Nozzle size=250 μm.

FIGS. 7E-7H show images of a 4D printed structure (90°/0° bilayer) including the same stimuli-responsive clay-based hydrogel as used in FIGS. 7A-7D; however, instead of cellulose fibrils, single-walled carbon nanotubes are employed as the anisotropic filler particles. Due to the presence of the carbon nanotubes, the reversible shape change may be effected by heat and/or infrared light.

FIG. 7I shows portions of stimuli-responsive hydrogel composite filaments seeded with cells.

FIG. 8 shows the print path of longitudinal (bottom) and transverse (top) tensile specimens.

FIGS. 9A-9C show print paths (top) and final swollen 3D structures (bottom) that display positive, negative and varying Gaussian curvature, respectively, where the scale bar is 2.5 mm.

FIG. 9D shows that bending and twisting conformations are possible with strips of 90°/0° (left) and −45°/45° (right), where the scale bar is 5 mm.

FIG. 9E shows that a gradient in local interfilament spacing can generate a logarithmic spiral, where the scale bar is 5 mm.

FIG. 9F shows that breaking lateral symmetry in print path order takes a ruffled structure (left) to a helicoidal structure (right), where the scale bar is 10 mm.

FIG. 10A shows a complex flower morphology (right and bottom) formed by hydrating a 3D printed structure composed of 90°/0° bilayers oriented with respect to the long axis of each petal (left).

FIG. 10B shows a complex flower morphology (right and bottom) formed by hydrating a 3D printed structure composed of −45°/45° bilayers oriented with respect to the long axis of each petal (left).

FIGS. 10C-10E show the print path and printed structure, respectively, prior to hydration to form a 3D architecture inspired by a native orchid, the Dendrobium helix, as shown in FIG. 10F. Based on the print path, the orchid architecture exhibits four different configurations: bending, twisting, and ruffling corolla surrounding the central funnel-like domain. Scale bars are 5 mm.

FIG. 10G shows curvature as a function of time during hydration of the 90°/0° flower bilayer.

FIGS. 11A-11B show images of 3D printed filament structures that differ in interfilament spacing (where interfilament spacing increases from left to right in each photo); nozzle size is 250 microns. The images of the 3D printed structures after swelling (FIGS. 11C-11D) reveal that curvature increases as interfilament spacing increases.

FIG. 12A shows a native calla lily flower; FIG. 12B shows a mathematically generated model of the flower; FIG. 12C shows that the curvature of the flower may be extracted from the mathematically generated model; FIG. 12D shows the two-layer print path obtained from the curvature data and the arrangement of filaments in each layer, where printing is carried out with a nozzle size of 410 microns; and FIG. 12E shows the 3D printed structure after hydration and consequent swelling to the predetermined calla lily shape (the scale bars represent 5 mm).

### DETAILED DESCRIPTION

3D printing can be used to create hydrogel composite filamentary structures encoded with localized, anisotropic swelling behavior that can be triggered by exposure to water. The local swelling behavior may be controlled by the alignment of anisotropic (high aspect ratio) filler particles along prescribed printing pathways. When combined with a theoretical framework that provides a solution to the inverse problem of designing the alignment patterns for prescribed target shapes, it is possible to 3D print arrangements of hydrogel composite filaments that predictably change shape when hydrated, yielding complex plant-inspired and/or other architectures. It is also possible to use a 3D printed arrangement of hydrogel composite filaments to induce a controllable shape change in an underlying flexible substrate. The combination of 3D printed composite filamentary structures with programmable swelling upon exposure to water can be referred to as biomimetic 4D printing, or simply 4D printing.

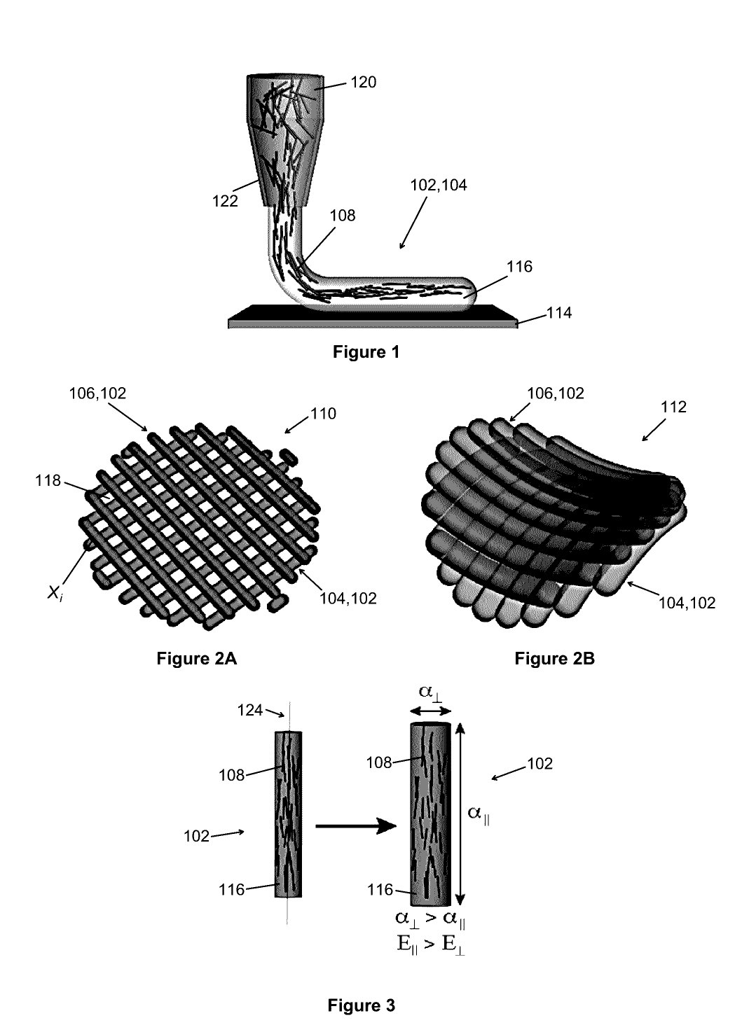

The elastic and swelling anisotropies of a hydrogel composite filament can be influenced or determined by the orientation of stiff, anisotropic particles within the filament. The embedded anisotropic filler particles may take the form of fibrils, fibers, nanotubes, nanowires, whiskers, platelets or another high aspect ratio morphology. During 3D printing, the anisotropic filler particles 108 may undergo shear-induced alignment within the hydrogel matrix 116 as the composite ink formulation 120 is extruded through a deposition nozzle 122, as illustrated in FIG. 1. Thus, the 3D printing process may yield composite filaments 102 with longitudinally-oriented particles 108 and a predetermined anisotropic stiffness, such that differential swelling occurs along the length of the filament as defined by the print path (longitudinal direction 124) compared to the transverse direction.

Referring to FIGS. 1, 2A and 2B, the 4D printing method may entail depositing a first layer 104 of filaments 102 on a substrate 114 in a first predetermined arrangement, where each filament 102 comprises a hydrogel 116 with anisotropic filler particles 108 embedded therein. A second layer 106 of the filaments 102 may be deposited in a second predetermined arrangement on the first layer 104, such that the filaments 102 of the second layer 106 contact the filaments 102 of the first layer 104 at a number of contact regions Xᵢ, where i=1, 2 . . . n. It should be noted that i may have any integer value without limit (e.g., n may be as high as 10, 10², 10³, 10⁴, 10⁵, or 10⁶, or even higher). After deposition, the filaments 102 of the first and second layers 104,106 may be hydrated. The filaments 102 swell in size while remaining in contact at the contact regions Xᵢ to reach a predetermined curved shape 112. In a typical example, the first and second layers 104,106 of filaments 102 have a planar arrangement 110 that morphs into a nonplanar curved shape 112 upon hydration. Due to the swelling, some or all of the space 118 between the as-deposited filaments 102 may be filled in after hydration, leading to the formation of a swollen 3D shape 112 having either no porosity or a decreased amount of porosity compared to the as-printed (pre-hydration) configuration.

In another example, a layer of hydrogel composite filaments 102 may be deposited in a predetermined arrangement onto a flexible substrate in order to induce a controllable shape change in the flexible substrate upon hydration of the hydrogel composite filaments. In this case, after deposition, the filaments may contact the flexible substrate at one or more contact regions, depending on the morphology of the flexible substrate (e.g., whether solid or porous). In one example, the flexible substrate may take the form of a textile comprising natural and/or synthetic fibers.

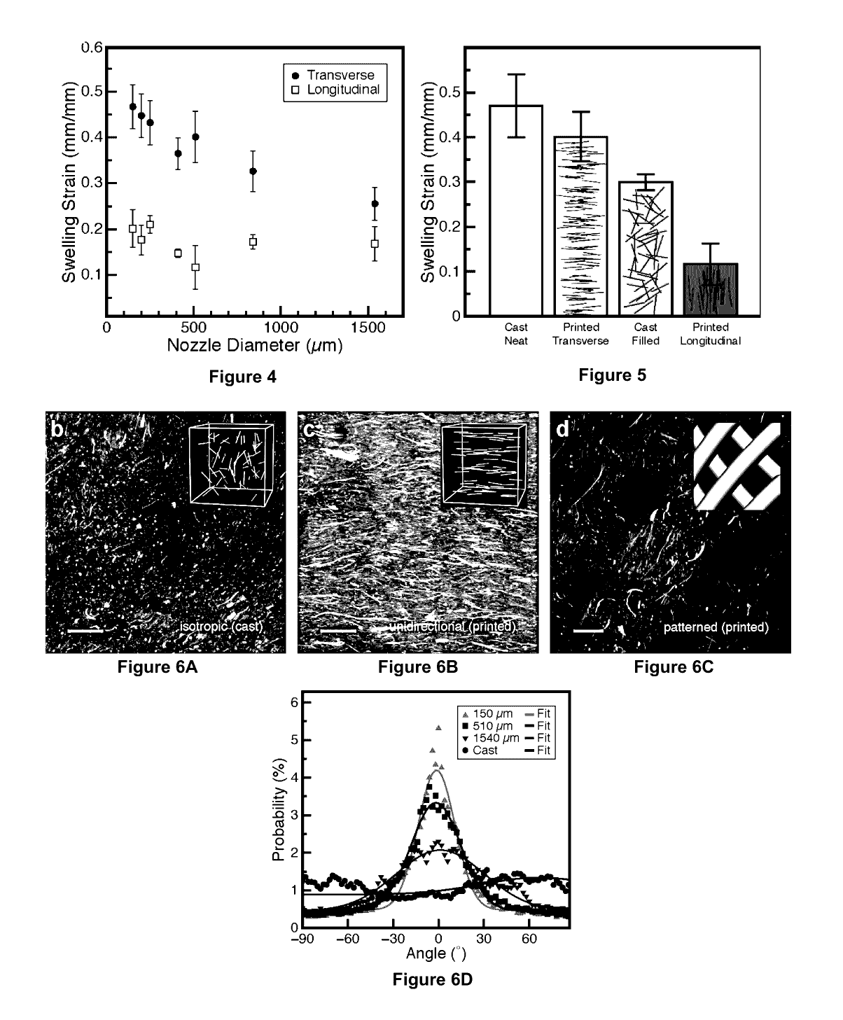

The anisotropic filler particles 108 embedded in the hydrogel composite filament 102 may be at least partially aligned or highly aligned with a longitudinal axis of the filament 102, as defined below. Accordingly, the swelling of the hydrogel composite filaments may be greater along the transverse axis (or short axis) than along the longitudinal axis (or long axis), as illustrated in FIG. 3. Data indicate that 3D printed filaments including high aspect ratio particles with high alignment along the print direction may exhibit up to a four-fold difference in longitudinal and transverse swelling (e.g., α_{∥}=10% and α_{⊥}=40%, respectively) as shown by the swelling strain data of FIGS. 4 and 5.

Generally speaking, a ratio of the swelling along the short axis α_{⊥} to the swelling along the long axis α_{∥} may be at least about 1.5, at least about 2, at least about 2.5, or at least about 3. This ratio, which may be referred to as the “swelling ratio,” may also be as high as about 10, as high as about 6, or as high as about 4. The extent of the shear-induced alignment, and thus the magnitude of the anisotropic swelling, depends at least in part on the nozzle diameter and printing speed. For a fixed printing speed, the shear forces that promote alignment of the anisotropic filler particles may scale inversely with nozzle size.

Hydrating the filaments may entail exposing the layers to water or an aqueous solution by dipping, immersion, spraying, or another deposition method. The hydrating may also or alternatively entail exposing the first and second layers of filaments to a humid environment, such as an air environment having a humidity of at least about 40%, at least about 60%, or at least about 80%.

The composition of the hydrogel composite ink formulation used to print the hydrogel composite filaments is critical to the success of the 4D printing process. The hydrogel composite filaments may be formed from a hydrogel composite ink formulation by extrusion through a deposition nozzle. As would be recognized by one of ordinary skill in the art, the composition of the deposited hydrogel composite filaments and the hydrogel composite ink formulation extruded through the nozzle may be the same or substantially the same (allowing for, for example, some minuscule amount of evaporation or other changes during 3D printing). It is also understood that both the hydrogel composite ink formulation and the hydrogel composite filaments, prior to polymerization, comprise an uncured hydrogel that may be defined in terms of the constituent monomer(s). Given this understanding, the term “hydrogel” or “hydrogel matrix” may be used in reference to both uncured and cured (or crosslinked) hydrogels throughout this disclosure.

The hydrogel composite ink formulation may include one or more monomers comprising an acrylamide and/or an acrylate, anisotropic filler particles, clay particles, a polymerization initiator, and an oxygen-scavenging enzyme in an aqueous solvent. The one or more monomers are polymerized to form a hydrogel matrix that readily swells upon exposure to water. The clay particles may serve as a crosslinker for the monomer(s) as well as a rheological aid in the ink composition that promotes the viscoelastic behavior required for 3D printing. The oxygen-scavenging enzyme can scavenge ambient oxygen, which can otherwise inhibit or prevent polymerization of the monomer(s) during curing. The anisotropic filler particles may serve as stiff reinforcements with an elastic modulus (E) in excess of 100 GPa and/or exhibit other functionalities, such as electrical conductivity or bioactivity. The aqueous solvent may comprise the balance of the ink formulation considering the concentrations of the other components as set forth below.

In one example, hydrogel composite filaments may include stiff cellulose fibrils embedded in an acrylamide matrix, which mimics the composition of plant cell walls. The hydrogel composite filaments may be 3D printed from ink formulation comprising an aqueous suspension of N,N-dimethylacrylamide (or N-isopropylacrylamide for reversible systems, as discussed below) along with nanofibrillated cellulose (NFC) and a photoinitiator. The aqueous suspension may also include clay particles, glucose oxidase and glucose, as discussed below.

Referring to FIGS. 6A-6C, significant cellulose fibril alignment can be observed in 3D printed hydrogel composite filaments compared to isotropic cast sheets of the same material. Fourier analysis of stained images is used to quantify the relative alignment between the cast and printed specimens. As shown by the data in FIG. 6D, 3D printed filaments exhibit a clear peak at 0°, corresponding to the print direction, while the isotropic samples show no clear directional peaks.

After printing, the monomer(s) may be polymerized to form a crosslinked hydrogel matrix. Typically, the polymerization entails photopolymerization using UV light. Thus, the polymerization initiator used in the composite ink formulation may be a photoinitiator, such as Irgacure® 2959 from BASF Corp. Photopolymerization may be carried out by exposing the hydrogel composite filaments to UV light for a time duration ranging from 5 seconds to about 10 minutes. Typically, the time duration is from about 1 minute to about 3 minutes.

When clay particles are included in the ink formulation, the monomer(s) may be physically cross-linked by the clay particles during polymerization, thereby increasing the mechanical strength of the hydrogel matrix. Recent modeling suggests that an increase in clay content may result in an increase in the formation of interparticle crosslinking polymer chains during polymerization. Polymerization can be initiated from the surface of the clay particles due to their high cationic exchange capacity. The hydrogel formed during polymerization when clay particles are employed in the ink formulation may exhibit increased stretchability and strength compared to covalently-crosslinked hydrogels formed without clay.

Since higher clay concentrations may result in higher crosslink densities and lower swelling, excessively high concentrations of clay are avoided in the ink formulation for 4D printing applications. Preferably, the concentration of the clay particles is about 20 wt. % or less or about 10 wt. % or less, and typically is at least about 5 wt. %. Concentrations of clay within this range may yield printed hydrogel filaments that can flow and retain their shape as desired. In one example, the clay particles may comprise synthetic hectorite clay, which is commercially available from Southern Clay Products, Inc. as Laponite XLG.

Typically, printing and curing are carried out under ambient conditions. Accordingly, the presence of an oxygen-scavenging enzyme in the ink formulation may drastically improve polymerization. Oxygen inhibition, which refers to the oxygen-induced inhibition of curing in polymers undergoing free-radical polymerization, can be a major challenge in the 3D printing of hydrogel-based inks. When oxygen inhibition is not addressed, a hydrogel composite filament may include hundreds of microns or more of poorly cured surface gel. An oxygen-scavenging enzyme, such as the naturally occurring glucose oxidase, can dramatically improve the polymerization of aqueous hydrogel ink formulations under ambient conditions. It has been observed that, without the enzyme, it may be difficult or impossible to cure 3D printed hydrogel composite filaments of about 200 μm in diameter in an ambient environment; however, when glucose oxidase is present, cured hydrogel composite filaments may be formed with no detectable oxygen inhibition. Typically, the oxygen scavenging enzyme is present in the hydrogel composite ink formulation at concentration in the range of from about 0.1 wt. % to about 10 wt. %. For example, the ink formulation may include an oxygen scavenging enzyme in an amount of at least about 0.1 wt. %, or at least about 1 wt. %, and typically no more than about 10 wt. %, or no more than about 8 wt. %. When the oxygen scavenging enzyme is glucose oxidase, and glucose is further included in the ink formulation, the glucose may be present at a concentration of from about 1 wt. % to about 40 wt. %.

Exemplary monomers that may be suitable for the hydrogel composite ink formulation include one or more of the following: N,N-dimethylacrylamide (DMAm), N-isopropylacrylamide (NIPAm), and sodium acrylate. A monomer comprising an acrylamide or an acrylate may be physically crosslinked by the clay particles during polymerization, as described above, and also exhibits significant swelling when exposed to water. Typically, the monomer(s) are present in the ink formulation at a concentration in the range of from about 1 wt. % to about 30 wt. %. For example, the concentration of monomer in the composite ink formulation may be at least about 1 wt. %, at least about 5 wt. %, or at least about 10 wt. %. Typically, the concentration of monomer in the composite ink formulation is no greater than about 30 wt. %, no greater than about 25 wt. %, or no greater than about 20 wt. %.

Depending on the composition, the monomer may in some cases be polymerized to form a stimuli-responsive polymer that can exhibit reversible shape change behavior. Such monomers may be referred to as stimuli-responsive monomers, and monomers that do not form stimuli-responsive polymers may be referred to as nonresponsive monomers. Generally speaking, a 4D printed structure comprising a stimuli-responsive polymer may return to a contracted configuration (e.g., the initial printed configuration or configuration prior to swelling) upon exposure to a suitable stimulus, such as a change in temperature, light, or pH.

For example, NIPAm may be polymerized to form poly(N-isopropylacrylamide) (PNIPAm), which can undergo a thermoreversible shape change. Accordingly, after hydration under ambient conditions, a hydrogel composite filament comprising a PNIPAm matrix may be substantially or fully returned to its initial printed configuration by exposure to elevated temperatures (e.g., a warm water bath). If desired, the swollen or 4D printed configuration may be obtained again simply by reducing the water temperature.

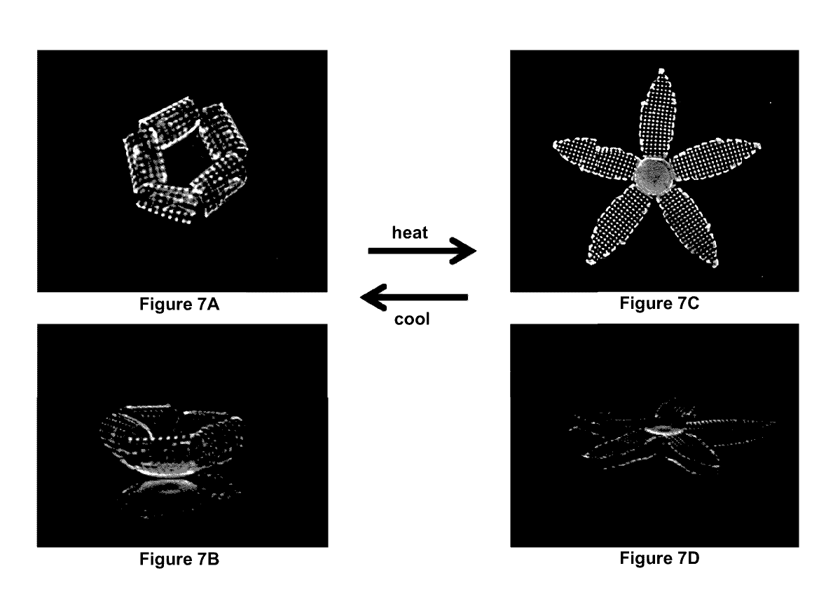

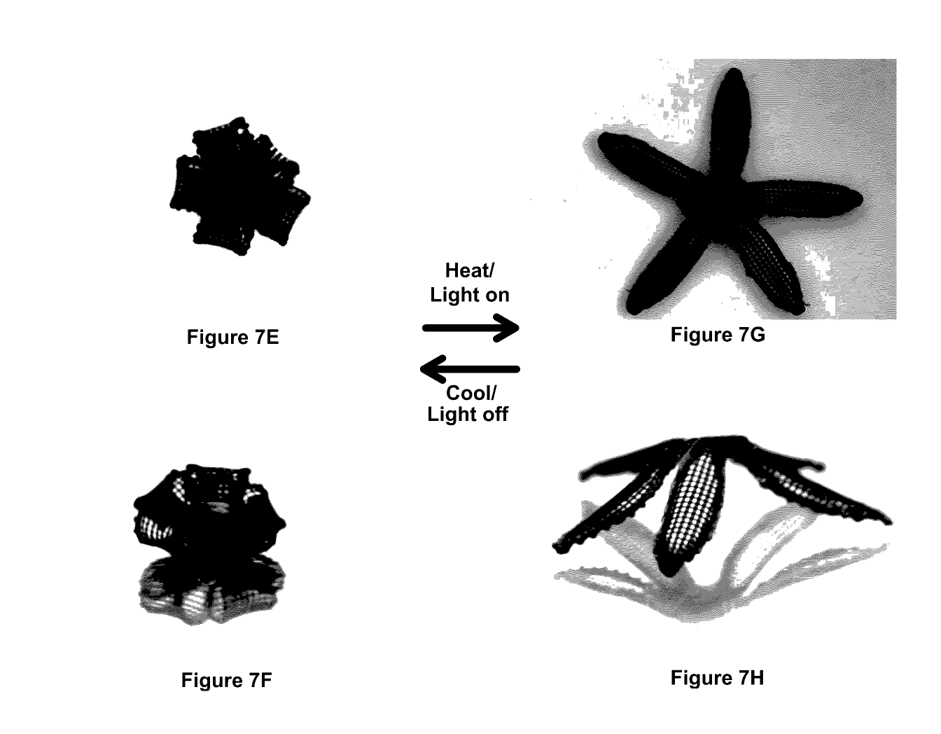

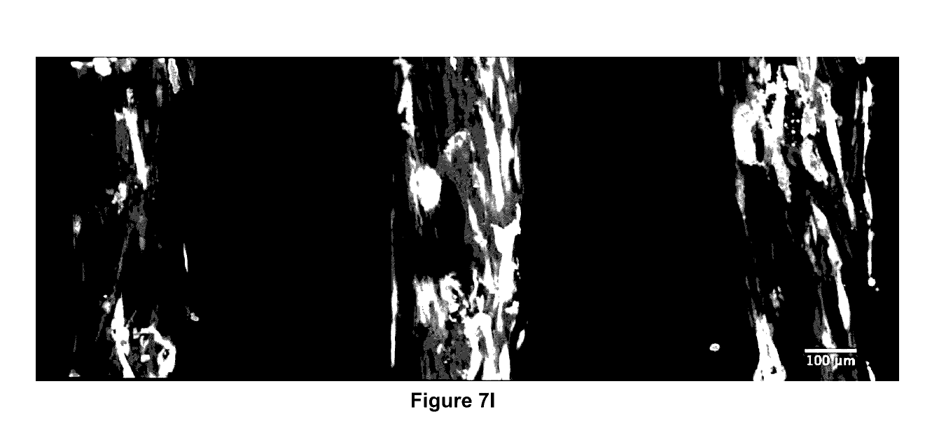

Such thermoreversible behavior is illustrated in FIGS. 7A-7D, which show a reversible, temperature-induced shape change of a 4D printed flower structure composed of a PNIPAm hydrogel matrix including cellulose fibrils (0.8 wt. %). The flower structure maintains the swollen configuration in room temperature water, as shown in FIGS. 7A-7B, but upon exposure to a 50° C. warm water bath, the hydrogel matrix contracts and substantially returns to the initial, 3D printed planar configuration, as shown in FIGS. 7C-7D. The transformation can be cycled back and forth by changing the water temperature, where heating leads to contraction and cooling leads to swelling. The shape change is believed to be due to the coil-to-globule transition of the PNIPAm.

In another example shown in FIGS. 7E-7H, a reversible shape change may be achieved in a hydrated 3D printed structure by the application of heat or light (e.g., infrared (IR) light). The same stimuli-responsive clay-based hydrogel as used in FIGS. 7A-7D is used in this example; however, single-walled carbon nanotubes are employed as the anisotropic filler particles instead of cellulose fibrils. The reversal with heat is very rapid due to the increased thermal conductivity afforded by the carbon nanotubes (0.4 wt. % in this example) in the hydrogel. In addition, since the carbon nanotubes can absorb IR energy and convert it to heat, thereby activating a phase change transition of the PNIPAm, it is possible to achieve shape reversal by exposing the hydrated hydrogel composite to IR radiation. Such structures may be useful for transformative electronics or photonics, as well as for bioelectronic applications, where the conductivity of carbon nanotubes may enable electrical signaling of cells such as neurons and/or muscle cells.

For some applications, the hydrogel composite filaments may be seeded with cells, e.g., with a plurality of one or more types of cells. The seeding may occur before or after deposition of the filaments. For example, as described in International Patent Application No. PCT/US2014/063810, which is hereby incorporated by reference in its entirety, the cells may be incorporated into the composite ink formulation prior to depositing the hydrogel composite filaments. In another example, the seeding may be carried out after deposition, polymerization, hydration, and/or shape reversal (contraction) of the filaments. Carrying out the seeding post-polymerization may be advantageous to ensure that the cells are not exposed to unreacted monomer or clay particles, which may be detrimental or toxic to the cells. Cell seeding may be carried out after deposition using a suitable cell culture medium and techniques known in the art. When cell seeding is desired, it may be advantageous to produce the hydrogel composite filaments from a hydrogel that does not contain clay or from another suitable material, such an extracellular matrix material as set forth in PCT/US2014/063810. Furthermore, the hydrogel composite filaments may contain hydroxyapatite particles and/or another type of bioactive particle (e.g., as the anisotropic filler particles).

In another example demonstrating the potential usefulness of reversible shape change behavior and cell seeding, a stimuli-responsive 4D printed flower structure comprising hydrogel composite filaments is seeded with cells. Referring to FIG. 7I, the hydrogel composite filaments include a PNIPAm hydrogel matrix and cellulose fibrils embedded therein. The hydrated flower is first coated with fibronectin (a common protein used to increase cell adhesion), and equilibrated at 37° C., which transforms the flower to the flat configuration. The cells (green fluorescent protein (GFP) expressing fibroblasts) are seeded on top and allowed to grow. This seeded hydrogel composite structure is fixed and stained after 10 days of culture to reveal the actin filaments within the cells (red), with the green from the GFP. The highly aligned nature of the actin filaments indicates the cells preferentially align and spread in the direction of printing, where the hydrogel composite filament is stiffest. This approach may be used to interrogate cellular response in several ways. For example, the ability to actuate between shapes may facilitate investigating the role of curvature and geometry on cellular response. Volumetric expansion and contraction of the hydrogen composite structure may influence cell behavior, especially in cells that undergo these changes natively, as in muscles. In addition, the repetitive change in stiffness as a result of the swelling and deswelling of the hydrogel composite filaments could influence cell behavior, especially in stem cells and bone-lineage cells.

As indicated above, the anisotropic filler particles may exhibit a high stiffness to influence the swelling behavior of the hydrogel composite filament. The filler particles may also or alternatively exhibit another functionality to impart a desired property to the hydrogel composite, such as electrical conductivity, bioactivity, or magnetic behavior. The anisotropic filler particles may comprise cellulose, carbon (e.g., carbon nanotubes), silicon, hydroxyapatite, a metal or alloy (e.g., Ag, Cu, Al, Au, Co, Cr, Ni, Pt, Sn, Ti, and/or Zn), an oxide (e.g., SiO₂, Al₂O₃, TiO₂, ZnO, SnO, ITO, BaTiO₃, FeO₂, and/or Fe₃O₄) or another material having a desired property. The anisotropic filler particles may take the form of, for example, fibers, fibrils, whiskers, platelets, microfibers, nanofibers, nanotubes and/or nanowires. The concentration of the anisotropic filler particles in the composite ink formulation may be at least about 0.01 wt. %, at least about 0.04 wt. %, at least about 1 wt. %, or at least about 5 wt. %. The concentration of the anisotropic filler particles may also be no greater than about 30 wt. %, no greater than about 20 wt. %, no greater than about 15 wt. %, or no greater than about 10 wt. %.

By definition, the anisotropic filler particles have an aspect ratio greater than 1, where the aspect ratio may be defined as a length-to-width ratio. In some cases, the aspect ratio may refer to a length-to-thickness ratio. If the width and the thickness of a particle are not of the same order of magnitude, the term “aspect ratio” may refer to a length-to-width ratio. If the anisotropic filler particles are agglomerated, the aspect ratio relevant to the properties of the ink formulation and the hydrogel composite filament may be the aspect ratio of the agglomerated particles.

At least some fraction of, or all of, the anisotropic filler particles may have an aspect ratio greater than about 2, greater than about 5, greater than about 10, greater than about 20, greater than about 50, or greater than about 100. Typically, the aspect ratio of the high aspect ratio particles is no greater than about 1000, no greater than about 500, or no greater than about 300. Such high aspect ratio particles may be at least partly aligned during 3D printing of the ink formulation, depending in part on the size and aspect ratio of the particles in comparison to the diameter of the deposition nozzle.

The anisotropic filler particles may have at least one short dimension (e.g., width and/or thickness) that lies in the range of from about 1 nm to about 50 microns. The short dimension may be no greater than about 20 microns, no greater than about 10 microns, no greater than about 1 micron, or no greater than about 100 nm. The short dimension may also be at least about 1 nm, at least about 10 nm, at least about 100 nm, at least about 500 nm, at least about 1 micron, or at least about 10 microns.

The anisotropic filler particles may have a long dimension (e.g., length) that lies in the range of from about 5 nm to about 10 mm, and is more typically in the range of about 1 micron to about 5 microns, or from about 100 nm to about 500 microns. The long dimension may be at least about 10 nm, at least about 100 nm, at least about 500 nm, at least about 1 micron, at least about 10 microns, at least about 100 microns, or at least about 500 microns. The long dimension may also be no greater than about about 5 mm, no greater than about 1 mm, no greater than about 500 microns, no greater than about 100 microns, no greater than about 10 microns, no greater than 1 micron, or no greater than about 100 nm.

It should be noted that when a set of particles—or more generally speaking, more than one particle—is described as having a particular aspect ratio, size or other characteristic, that aspect ratio, size or characteristic can be understood to be a nominal value for the plurality of particles, from which individual particles may have some deviation, as would be understood by one of ordinary skill in the art.

Returning now to the 4D printing method, which may be summarized according to one embodiment as follows: A first layer of filaments is deposited in a first predetermined arrangement on a substrate, and then a second layer of filaments is deposited in a second predetermined arrangement on the first layer of filaments. Each of the filaments comprises a hydrogel matrix and anisotropic filler particles embedded therein, and thus may be referred to as a hydrogel composite filament. The filaments from the second layer contact the filaments from the first layer at a number of contact regions Xᵢ, where i=1, 2 . . . n. The first and second layers are exposed to water, and the filaments of the first layer and the second layer swell in size while remaining in contact at the contact regions to form a curved 3D shape.

According to another embodiment, the method may entail depositing a layer of filaments in a predetermined arrangement on a flexible substrate, where the filaments contact the flexible substrate at one or more contact regions. Each filament comprises a hydrogel matrix and a plurality of anisotropic filler particles embedded therein. The flexible substrate may be a solid or porous substrate, such as a fabric comprising a plurality of natural and/or synthetic fibers. The layer is hydrated, and the filaments swell in size while remaining in contact with the flexible substrate at the one or more contact regions. Thus, the flexible substrate is forced to adopt a predetermined curved shape.

Extrusion-based 3D printing may be used to deposit the hydrogel composite filaments in the desired arrangements according to the print path of a deposition nozzle. Thus, the hydrogel composite filaments may be formed from a hydrogel composite ink formulation by extrusion through a deposition nozzle. The substrate for deposition typically comprises a material such as glass or another ceramic, PDMS, acrylic, polyurethane, polystyrene or another polymer. In some cases, the substrate may not be a solid-phase material, but may instead be in the liquid or gel phase and may have carefully controlled rheological properties to support the deposited filaments.

As explained above, the anisotropic filler particles undergo shear-induced alignment as the hydrogel composite ink is extruded through the nozzle. Accordingly, the anisotropic filler particles embedded in the hydrogel matrix may be at least partially aligned—and in some cases highly aligned—with the longitudinal axis of each filament so as to generate anisotropic swelling behavior. Also as described above, the swelling of the hydrogel composite filaments may be greater along a transverse axis thereof than along the longitudinal axis, and swelling ratios ranging from about 1.5 to 10 are possible. In a bilayer system, differential swelling between the top and bottom layers can induce curvature if the layers are forced to remain in contact along the interfacial region. By constraining the hydrogel composite filaments at the contact regions Xᵢ, where each filament may be predisposed to anisotropic swelling, a curved 3D shape can be formed upon hydration.

For a bilayer printed architecture, each contact region Xᵢ may be understood to be an interfacial region between a portion of a filament from the first layer and a portion of a filament from the second layer. The size of the interfacial regions prior to swelling may be determined largely by the width of the filaments as well as by the relative orientation of the filaments at each of the contact regions. The relative orientation may be expressed as the angular offset θᵢ between a filament from the first layer and a filament from the second layer at each contact region Xᵢ.

In some cases, the method may further entail using a mathematical model to determine a suitable print path for deposition of the layers such that the filaments adopt a particular swollen 3D shape upon hydration. Inherent to determining the arrangements of filaments in each of the first and second layers is identifying the desired angular offset θᵢ at each contact region Xᵢ as well as the desired spacing between filaments in each layer. An exemplary mathematical model is summarized here and described in more detail below.

Any curved surface may be described by a mean curvature (H) and a Gaussian curvature (K) at any given point. The mathematical model utilizes, as inputs, the curvatures (H, K) for the desired curved surface (which may be referred to as a 3D shape or structure elsewhere in this disclosure) along with the longitudinal and transverse swelling strains (α_{∥} and α_{⊥}, respectively) and the elastic moduli of the hydrogel composite filaments.

$$H = {c}_{1} \frac{{α}_{∥} - α ⊥}{h} \frac{{sin}^{2} ( θ )}{{c}_{2} - {c}_{3} cos ( 2 θ ) + {m}^{4} cos ( 4 θ )}$$

$$K = - {c}_{4} \frac{{( {α}_{∥} - α ⊥ )}^{2}}{{h}^{2}} \frac{{sin}^{2} ( θ )}{{c}_{5} - {c}_{6} cos ( 2 θ ) + {m}^{4} cos ( 4 θ )}$$

Using this model, it is possible to solve for m and θ, which determine the spacing between filaments and the relative orientation of the filaments in each layer. Thus, the print path for the filaments in each layer may be determined.

In some cases, degree notation (e.g., 90°/0° or)−45°/45° may be used to describe the orientation of each printed layer in reference to an orthogonal grid pattern that may be defined by the boundary or an axis of the printed arrangement of filaments. The first number before the “/” represents the orientation of the top (second) layer with respect to the boundary/axis while the number after the “/” represents the orientation of the bottom (first) layer with respect to the boundary/axis. For example, in the case of a 90°/0° flower, the top layer is oriented at 90° with respect to the long axis of the petal, while the bottom layer is oriented at 0° with respect to the long axis of the petal.

All of the hydrogel composite filaments may comprise the same hydrogel matrix and anisotropic filler particles. Alternatively, some or all of the hydrogel composite filaments may comprise a different hydrogel matrix and/or different anisotropic filler particles to achieve, for example, different swelling ratios or different functionalities in different filaments or layers. For example, the first layer of filaments may comprise a first hydrogel matrix and a first type of anisotropic filler particles, and the second layer of filaments may comprise a second hydrogel matrix and/or second type of anistropic filler particles different from those of the first layer. The hydrogel matrix may be a hydrogel as described above or elsewhere in this disclosure, and the anisotropic filler particles may have any of the characteristics (composition, size, aspect ratio, etc.) set forth above or elsewhere in this disclosure. The hydrogel composite filaments deposited in the above-described method may further have any of the characteristics (e.g., composition, swelling ratio, etc.) set forth in this disclosure for the composite filaments.

Each of the hydrogel composite filaments deposited on the substrate may be a single continuous filament of a desired length or may be formed from multiple extruded filaments having end-to-end contact once deposited. A hydrogel composite filament of any length may be produced by halting deposition after the desired length of the filament has been reached. The desired length of the hydrogel composite filament may depend on the print path and/or the geometry of the structure being fabricated. Also, it should be noted that a hydrogel composite structure (e.g., the lattice structure shown in FIG. 2A or 2B) may be described as including a number of filaments even though it may be possible to deposit the filaments in a continuous process without starting or stopping.

The deposition nozzle may be moving with respect to the substrate during deposition (i.e., either the nozzle may be moving or the substrate may be moving, or both may be moving to cause relative motion between the nozzle and the substrate). Rotational motion of the nozzle is also possible to influence the alignment of the anisotropic particles, as described for example in International Patent Application No. PCT/US2015/015148, “Three-Dimensional (3D) Printed Composite Structure and 3D Printable Composite Ink Formulation,” which was filed Feb. 10, 2015, and is hereby incorporated by reference in its entirety.

The method may further comprise, prior to exposing the filaments to water, polymerizing the hydrogel so as to form a crosslinked hydrogel, thereby increasing the mechanical robustness of the filaments. The polymerization may be effected by light (e.g., UV light), heat, or a chemical, and may be aided by the presence of clay particles and/or an oxidation inhibitor (e.g., glucose oxidase and/or glucose) in the uncured hydrogel composite filament. Typically, polymerization is carried out after both the first and second layers of filaments have been deposited. This may be beneficial since, prior to curing, the hydrogel matrix may be more “sticky” and malleable, which can be conducive to forming a good bond between the layers at the contact regions Xᵢ. It is also possible, however, for the polymerization to be carried out during deposition of the filaments, or in separate steps after deposition of each layer.

As described above, hydration of the filaments to induce swelling may be carried out by exposing the layer(s) to water or an aqueous solution by dipping, immersion, spraying, or another deposition method. The hydrating may also or alternatively entail exposing the filaments to a humid gaseous environment, such as an air environment having a humidity of at least about 40%, or at least about 60%. Typically, room temperature water (e.g., about 20° C.-25° C.) is employed for the hydration.

The extent of anisotropic swelling of the hydrogel composite filaments depends strongly on the orientation of the filler particles within the hydrogel matrix. The anisotropic filler particles may be understood to be “at least partially aligned” with the longitudinal axis of the 3D printed hydrogel composite filament if at least about 25% of the anisotropic filler particles are oriented such that the length or long axis of the filler particle is within about 40 degrees of an imaginary line extending along the longitudinal axis of the composite filament. This imaginary line may also coincide with the print direction or print path. In some cases, the long axis of at least about 30%, at least about 35% or at least about 40% of the anisotropic filler particles may be oriented within about 40 degrees of the imaginary line.

The anisotropic particles may be understood to be “highly aligned” with the longitudinal axis of the 3D printed hydrogel composite filament if at least about 50% of the high aspect ratio particles are oriented such that the length or long axis of the filler particle is within about 40 degrees of an imaginary line extending along the longitudinal axis of the composite filament. This imaginary line may also coincide with the print direction or print path. In some cases, the long axis of at least about 60%, at least about 70%, at least about 80%, or at least about 90% of the anisotropic filler particles may be oriented within about 40 degrees of the imaginary line.

Depending on the anisotropic filler particles used and the processing conditions, it may be possible to produce hydrogel composite filaments having at least about 25% of the anisotropic filler particles oriented such that the length or long axis of each filler particle is within about 20 degrees of the imaginary line described above, or within about 10 degrees of the imaginary line. In some cases, at least about 30%, at least about 40%, at least about 50%, at least about 60%, at least about 70%, at least about 80%, or at least about 90% of the anisotropic filler particles may have a long axis oriented within about 20 degrees or within about 10 degrees of the imaginary line.

The above-described partial or high alignment of the anisotropic filler particles with respect to the longitudinal axis of the hydrogel composite filament may occur over an entire length of the filament or over only a portion of the length (e.g., over a given distance or cross-section).

### Experimental Examples

An exemplary procedure for creating 4D printed architectures involves preparing an ink formulation including clay, monomer, cellulose fibrils (nanofibrillated cellulose), photoinitiator, enzyme/glucose, and deionized water. Architectures are printed at room temperature in air, and UV cured after print completion. Samples are immersed in deionized water to allow for swelling and shape transformation.

A. Ink Preparation and Details:

An exemplary hydrogel composite ink formulation is prepared as follows. Nanofibrillated cellulose (NFC) is diluted from a stock solution to deoxygenated water under nitrogen flow, and mixed thoroughly using a Thinky mixer (ARE-310, Thinky Corp., Japan) in a closed container. Laponite XLG clay is then added under nitrogen flow and mixed again using the Thinky mixer. N,N-dimethylacrylamide (DMAm) (Sigma Aldrich, unmodified) is added to this NFC-clay solution under nitrogen flow and mixed again using the Thinky mixer. Irgacure 2959 (BASF), is added as the UV photonitiator. D-(+)-glucose (Sigma Aldrich) and glucose oxidase (from Aspergillus niger, Sigma Aldrich) are added as oxygen scavengers. Under nitrogen flow the ink is hand mixed, followed by mixing using the Thinky mixer. The final concentrations of each component are as follows: 77.6 wt. % deionized water, 0.73 wt. % NFC, 9.7 wt. % Laponite XLG clay, 7.8 wt. % DMAm, 0.097 wt. % Irgacure 2959, 0.23 wt. % glucose oxidase, 3.8 wt. % glucose. Finally 1 vol. % of a 5 mg/mL solution of a monomeric rhodamine dye (PolyFluor570-Methacryloxyethyl thiocarbonyl rhodamine B, Polysciences Inc.) is added under nitrogen flow and mixed using the Thinky mixer. Under nitrogen flow the ink is loaded into a syringe barrel and centrifuged to remove bubbles. The ink is then mounted to the printer and attached to a controlled air pressure input (Nordson EFD Inc.). Via luer-lock connection, a variety of commercial nozzles of varying diameter (Nordson EFD Inc.) can be attached. All nozzles were stainless-steel, straight tips, with 10 mm nozzle lengths.

B. Printing Procedure:

Print paths were generated via production of G-code which outputs the XYZ motion of the 3D printer (ABG 10000, Aerotech Inc.). G-code was generated either by hand, using MeCode python scripting (Jack Minardi (Voxel8), Daniel Fitzgerald (WPI)), or by scripting in Mathematica (Wolfram Research). Samples were printed on glass slides covered with a Teflon adhesive film (Bytac, Saint-Gobain) and cured for 200 s using an Omnicure UV source (Series 2000, Lumen Dynamics Inc.). After curing, the printed architecture is coated in a thin film of DI water to remove from the substrate. The sample was then immersed in DI water to allow for swelling and shape change.

C. Characterizing Alignment and Swelling:

To test NFC alignment, unidirectional, solid-infilled samples were printed with various sizes of nozzles (150-1500 μm diameter). NFC filled and unfilled cast hydrogel samples were also fabricated for comparison. Longitudinal (print direction) and transverse strains were calculated by measuring sample dimensions as-fabricated and after reaching equilibrium swelling in DI water, or approximately 5 days. These samples were then stained via immersion in 5 mL of a 0.1 mg/mL solution of Calcofluor White (Sigma Aldrich), with 200 μL of 10 wt. % potassium hydroxide solution added, for 24 hours. They were removed from the staining solution and soaked in DI water for 24 hours, and then imaged via confocal microscopy (LSM710, Zeiss). Z slices of approximately 10 μm were acquired and stacked into maximum projection images using Image J. To quantify alignment, the ImageJ plugin Directionality (creator: Jean Yvez-Tinevez), was applied to the unmodified maximum projection images, resulting in a histogram of relative alignment in different orientations. A Gaussian fit is applied to the resulting histograms.

D. Mechanical Testing:

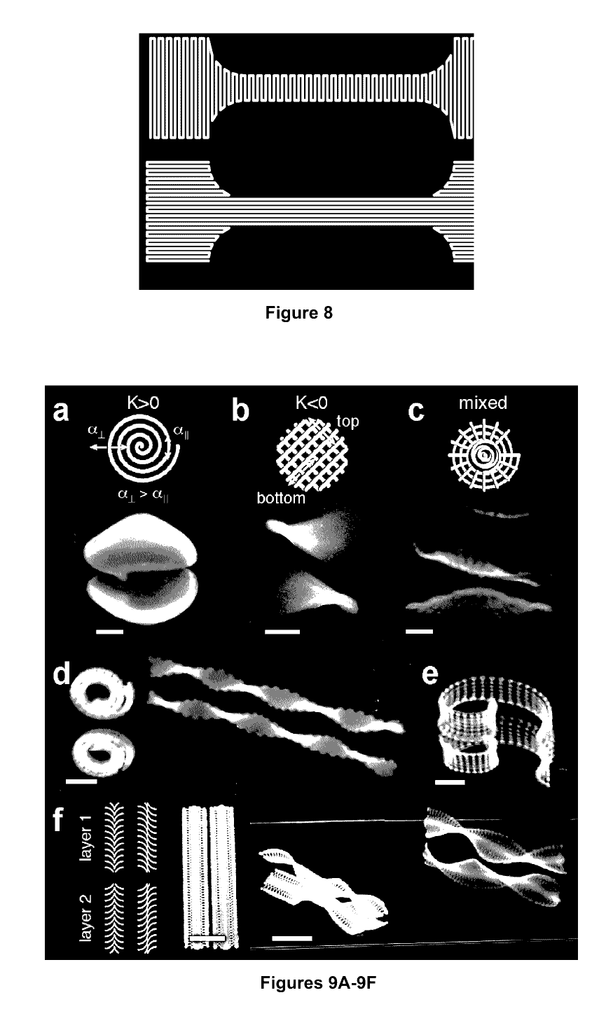

Tensile specimens were prepared via printing and curing. The print path of transverse and longitudinal orientations are shown in FIG. 8. Samples were tested either immediately after fabrication or after soaking in DI water for 5 days. The samples were tested on an Instron mechanical testing machine (Model 3342) with a 10 N load cell at a rate of 100 mm/min until failure. Stress and strain were calculated via initial specimen dimensions. Moduli were calculated from linear regions of the stress-strain curves.

E. Rheological Characterization:

Ink rheology was characterized via testing on a rheometer (DHR-3, TA Instruments) with a 40 mm diameter, 2.005° cone-plate geometry. Flow experiments were conducted via a logarithmic sweep of shear rates (0.1-1000 1/s). Oscillation experiments were conducted via a fixed frequency of 1 Hz and oscillatory strain of 0.01, with a sweep of stress (0.1-3000 Pa). All experiments were performed in ambient conditions with a gap height of 56 μm and preliminary soak time of 60 s.

F. Macro Imaging:

All photographic images were taken under a broad spectrum UV light source to excite the rhodamine dye in the ink. Images were taken with DSLR cameras (Mark III or Rebel T3i, Canon Inc.) with a variety of lenses. As-printed specimens were photographed in ambient conditions, while resulting shape transformations were captured in an acrylic enclosure containing deionized water.

G. Demonstrations of 4D-Printed Bilayer Architectures:

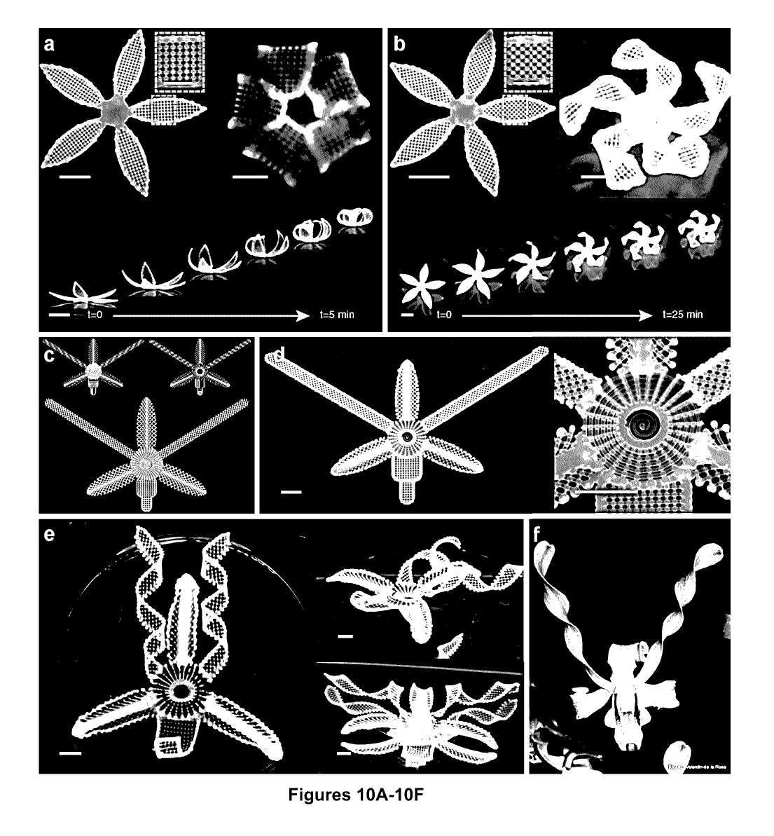

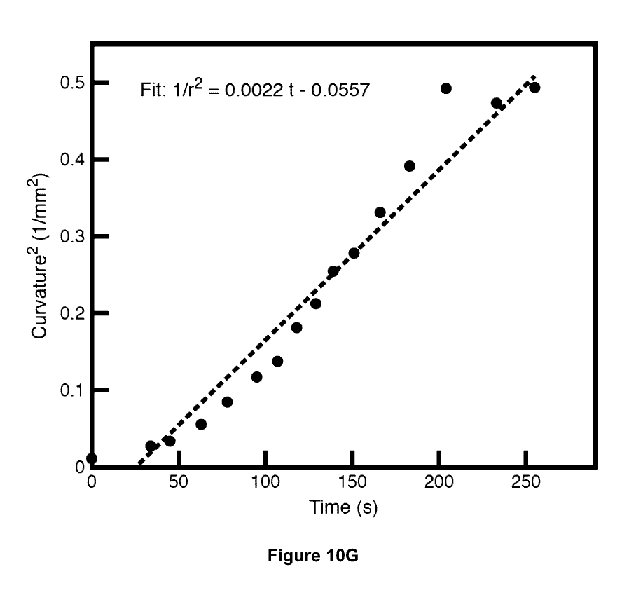

A series of simple bilayer architectures were 4D printed to explore the mathematical relationships discussed below and the quantitative connection between swelling, elastic anisotropy and the curvature of the target surface (FIGS. 9A-9F). The results demonstrate independent control over mean and Gaussian curvatures, the two invariants associated with the curvature of any surface.

Referring to FIG. 9A, positive Gaussian curvature can be generated by swelling concentric circles. The structure is conical (K˜0) far away from the tip, but has Gaussian curvature K˜ε²/h² concentrated near the apex. On the other hand, almost uniform negative Gaussian curvature associated with saddle-like shapes may be obtained from an orthogonal bilayer lattice that swells orthogonally, as shown in FIG. 9B. The orthogonal swelling of each layer yields a surface that is curved oppositely along two directions, i.e., a saddle-shaped surface with mean curvature H˜0 and Gaussian curvature K˜ε²/h². Combining these two morphologies produces a 4D printed sample with zones of both positive and negative Gaussian curvature, as shown in FIG. 9C. Simple structures that exhibit uniform cylindrical curvature (H≠0, K=0) can be obtained with a 90°/0° orientation of ink paths in the top and bottom bilayers, respectively, while −45°/45° yields twisted bilayer strips (FIG. 9D), similar to their natural counterparts, the Erodium awn and the Bauhinia seed pod, respectively. Since interfilament spacing acts as a proxy for the thickness, it is possible to make the curvature spatially inhomogeneous, leading, for example, to the logarithmic spiral shown in FIG. 9E. Overlapping circular arcs generate a structure that transitions from swelling primarily perpendicular to the spine of the petal to swelling primarily parallel to the border, leading to a surface with varying K, as shown in FIG. 9F. This structure exhibits negative Gaussian curvature, which increases towards the edge. Similarly, in the print path of a ribbon, breaking translational symmetry across the midplane and replacing it by reflection symmetry yields a ruffled structure, while breaking the reflection symmetry yields a helicoid. As evidenced by the figures, 4D printing allows control over the curvatures of both solid (infilled) structures and lattice-based structures with varying porosity (or filament spacing).

By combining patterns that generate simple curved surfaces, a series of functional folding flower architectures were created to demonstrate the capabilities of 4D printing. Inspired by a flower opening/closing, petals were printed in a floral form, as shown in FIG. 10A, comprised of a bilayer lattice with a 90°/0° orientation, similar to prior bilayer strips. As a control, an identical pattern was printed using an ink devoid of microfibrils, and it was observed to remain flat upon swelling. When the petals are printed with the ink filaments of the bilayer in a −45°/45° orientation, as shown in FIG. 10B, the structure swells to exhibit a twisted configuration; the chirality is due to broken top-bottom symmetry of the bilayer and thence differential swelling across the thickness. Importantly, these constructs contain spanning filaments that are readily fabricated by direct writing of the viscoelastic composite ink. The interfilament spacing promotes rapid uptake of water through the filament radius (˜100 μm), leading to shape transformations that occur on the order of minutes, consistent with diffusion-limited dynamics, as shown in FIG. 10G.

By replacing the poly(N,N-dimethylacrylamide) (PDMA) matrix with stimuli-responsive poly(N-isopropylacrylamide) (PNIPAm), it is possible to achieve reversible shape changes in water of varying temperature, as discussed above in reference to FIGS. 7A-7D. The 4D structure is obtained after 3D printing composite ink filaments in a 90°/0° bilayer and swelling in room temperature water (FIGS. 7A-7B). Reversal of the swelling (“deswelling” or contraction) occurs at an elevated water temperature (FIGS. 7C-7D).

Reversal of the swelling of the PNIPAm matrix can also be effected by light exposure (e.g., IR radiation) when the anisotropic filler particles include carbon nanotubes in addition to or instead of the cellulose fibrils used in the previous example, as discussed above in reference to FIGS. 7E-7H. The 4D structure is obtained after 3D printing composite ink filaments in a 90°/0° bilayer and swelling in room temperature water (FIGS. 7E-7F). Reversal of the swelling occurs at an elevated water temperature or upon exposure to IR radiation (FIGS. 7G-7H).

As an example of the versatility of the printing method, the complex shape of the orchid Dendrobium helix may be reproduced by encoding multiple shape changing domains. The print path is designed with discrete bilayer orientations in each petal (FIG. 10C-10D). The resulting 3D morphology shown in FIG. 10E following swelling in water resembles the orchid (FIG. 10F) and exhibits four distinct types of shape change (three different petal types and the flower center), based on configurations demonstrated in FIG. 9B-9C and FIGS. 10A-10B.

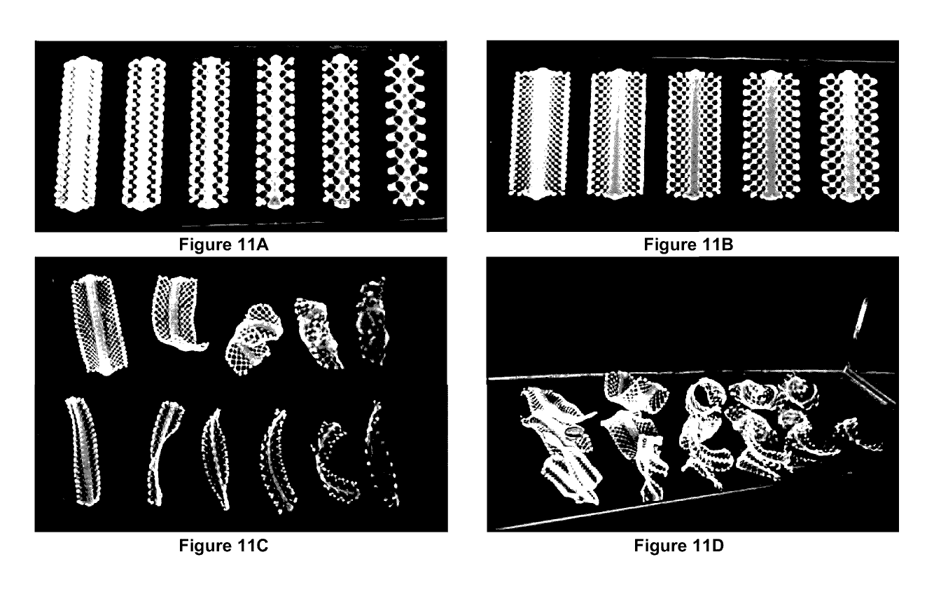

FIGS. 11A-11B show images of 3D printed filament structures that differ in interfilament spacing (where interfilament spacing increases from left to right in each photo); nozzle size is 250 microns. The images of the 3D printed structures after swelling (FIGS. 11C-11D) reveal that curvature increases as interfilament spacing increases.

### Mathematical Model

Harnessing anisotropic swelling can allow for precise control over curvature in bilayer structures. As discussed above, differential swelling between the top and bottom layers of a bilayer system can induce curvature if the layers are forced to remain in contact along the entire midplane. Quantifying the curvature induced in bilayer structures as a consequence of anisotropic swelling (the “forward problem”) may utilize a mathematical model for the mechanics of anisotropic plates and shells. Such a model combines aspects of the classical Timoshenko model for thermal expansion in bilayers with a tailored metric-driven approach that employs anisotropic swelling to control the embedding of a complex surface.

A mathematical model may also be employed to solve the inverse problem, that is, how to determine, based on a desired 3D curved shape, the requisite arrangement of hydrogel composite filaments in each layer of the bilayer structure—and thus the two-layer print path—in order to achieve the desired 3D curved shape upon swelling. More specifically, a suitable mathematical model can identify the predetermined angle θᵢ for each contact region Xᵢ between the layers as well as a suitable spacing between the filaments in each layer.

A. Mathematically Solving the Forward Problem:

In a bilayer system, differential swelling between the top and bottom layers induces curvature, since the layers are forced to remain in contact along the entire midplane. Consequently, the displacements, integrated from the swelling and curvature strain tensors, and traction along the midplane may be identical. Reflecting these boundary conditions, the model considers a printed structure produced by a given print path and consequently the anisotropic particles having a bottom layer oriented along the eₓ direction and the top layer rotated by θ degrees counterclockwise. The resulting curvatures depend on the elastic moduli, the swelling ratios, the ratio of layer thicknesses m=a_{bottom}/aₜₒₚ and total bilayer thickness h=aₜₒₚ+a_{bottom}.

The height of each layer and the total height can be tuned by nozzle size, and the “effective thickness” of the bilayer is influenced by the filament spacing. The areal size and shape of the printed bilayer (as determined at the boundaries) with respect to the thickness may also influence the final curvatures, as well as the orientation of the arrangement of filaments with respect to the boundary of the bilayer (where, for example, 90/0° and -45/45° represent different orientations of the arrangements of filaments, although the filaments of each layer have the same angular offset (θ=90°). The swelling ratio can be tuned by controlling the composition and structure of the hydrogel composite filaments—e.g., the amount of clay, the type and amount of the anisotropic filler particles, the degree of alignment of the anisotropic filler particles, and the properties of the hydrogel matrix (e.g., how much the polymer tends to swell).

The mean and Gaussian curvatures scale, respectively,

$$H = {c}_{1} \frac{{α}_{∥} - α ⊥}{h} \frac{{sin}^{2} ( θ )}{{c}_{2} - {c}_{3} cos ( 2 θ ) + {m}^{4} cos ( 4 θ )}$$

$$and$$

$$K = - {c}_{4} \frac{{( {α}_{∥} - α ⊥ )}^{2}}{{h}^{2}} \frac{{sin}^{2} ( θ )}{{c}_{5} - {c}_{6} cos ( 2 θ ) + {m}^{4} cos ( 4 θ )}$$

where the cᵢ are functions of the elastic constants and m. In the limit that θ→0°, the classical Timoshenko equation is recovered, while perpendicular layers (θ=90°) return a saddle-shaped structure. The mean curvature and gaussian curvature may be obtained at every node and then integrated to give the full 3D curvature of the resulting shape. The details of the forward problem to find curvatures of the target surface given print paths, bilayer anisotropy and interfilament spacing are provided below.

The classical Timoshenko theory for bimetallic strips has been generalized to account for the anisotropy of the ink as well as the intrinsically two-dimensional patterning enabled by the printing method. Motivated by the theory of laminated composites, the mathematical model considers a bilayer patch of total height h of hydrogel composite ink that swells anisotropically because the anisotropic particle alignment affects the elastic moduli and therefore the swelling strain tensor,

$${∈}^{s} = ( \begin{matrix}{α}_{∥} & 0 \\ 0 & α ⊥\end{matrix} ) .$$

The ink may be treated as an orthotropic elastic material, which satisfies the stress-strain relationship σᵢⱼ=Eᵢⱼₖₗε^{e}ₖₗ, (throughout the standard Einstein summation convention aᵢbiⱼ=Σᵢ²=1aᵢbiⱼ), where the total strain tensor ε=ε^{e}+ε^{s} is the sum of the elastic ε^{e} and swelling ε^{s} strain tensors, and the only non-zero components of the elastic moduli tensor Eᵢⱼₖₗ are Eₓₓₓₓ=E_{∥}, E_{yyyy}=E⊥ and E_{xyxy}=Eₓ. Without loss of generality, the print path of the first layer is taken to be along eₓ and the second layer to be in the cos(θ)eₓ+sin(θ)e_{y}, direction. The elastic moduli and strain tensors of the second layer transform according to E_{mnpq}(θ)=rᵢₙ(θ)rⱼₙ⁻¹(θ)rₖₚ(θ)r_{lq}⁻¹(θ)Eᵢⱼₖₗ and εᵢⱼ(θ)=rₗₖ(θ)r⁻¹(θ)ⱼεₖₗ, where rᵢⱼ(θ) and rᵢⱼ⁻¹(θ)=rⱼᵢ are components of the rotation matrix and its inverse (transpose), respectively, with rᵢⱼrₖⱼ=δᵢₖ.

For small deflections, the strain tensor in a thin film is given by εᵢⱼ=−zκᵢⱼ, where z is the distance is the distance from the interface and κᵢⱼ are components of the curvature tensor. At the boundary between layers, the displacements and tractions are continuous. In the unidirectional strain case, these boundary conditions are commonly solved by the introduction of a neutral surface, a location where all of the forces and torques balance. However, for anisotropic materials, this notion is ill defined. Each layer is subject to displacement coming from the swelling, u^{s}(x,y)=∫dAεᵢⱼ^{s}, which must be balanced by displacements due to curvature. The stress tensor is related to the curvature through the bending moments Mij=∫dzzσᵢⱼ=∫dzzEᵢⱼₖₗε^{e}ₖₗ. Combining these, the equilibrium condition is given by:

$$\int d A [ {∈}_{ij}^{s ( 1 )} + \frac{1}{{a}_{1}} {E}_{ijkl}^{- 1} ( 0 ) {M}_{kl} ] = \int d A [ {r}_{ik} ( θ ) {r}_{jl}^{- 1} ( θ ) {∈}_{kl}^{s ( 2 )} + \frac{1}{{α}_{2}} {E}_{ijmn}^{- 1} ( θ ) {M}_{mn} ] , \qquad ( 1 )$$

where Mᵢⱼ=∫_{-α}_{₁}Eᵢⱼₖₗ(θ)kₖₗz²dz+∫₀^{α}^{₂}Eᵢⱼₖₗ(θ)kₖₗz²dz are the bending moments per unit length and a₁ and a₂ are the layer thicknesses. Given ε^{s(1)} and ε^{s(2)} solutions to the system of Eqs. 1 yield the curvature tensor for the resulting swollen structure, and constitutes the forward problem. In the limit of unidirectional swelling, θ=0 and α_{⊥}=0, the classical Timoshenko result is recovered.

Given the swelling strains α_{∥} and α_{⊥} and elastic modulus tensor E, the system of Eqs. 1 can be solved for the for the curvature tensor, κ. It is then possible to obtain relations for the mean, H=1/2 Trκ and Gaussian, K=detκ curvatures, respectively,

$$\begin{matrix}H = 1 / 2 Tr ( κ ) = \frac{{α}_{∥} {α}_{⊥}}{2 h} ( \frac{{a}_{xy} ( {c}_{0} {b}_{xx} - {b}_{0} {c}_{xx} ) + {a}_{xx} ( {b}_{0} {c}_{xy} - {c}_{0} {b}_{xy} ) + {a}_{0} ( {b}_{xy} {c}_{xx} - {b}_{xx} {c}_{xy} )}{\begin{matrix}{a}_{yy} ( {b}_{xx} {c}_{xy} - {b}_{xy} {c}_{xx} ) + \\ {a}_{xy} ( {b}_{yy} {c}_{xx} - {b}_{xx} {c}_{yy} ) + {a}_{xx} ( {b}_{xy} {c}_{yy} - {b}_{yy} {c}_{xy} )\end{matrix}} + \frac{{a}_{yy} ( {c}_{0} {b}_{xy} - {b}_{0} {c}_{xy} ) + {a}_{xy} ( {b}_{0} {c}_{yy} - {c}_{0} {b}_{yy} ) + {a}_{0} ( {b}_{yy} {c}_{xy} - {b}_{xy} {c}_{yy} )}{{a}_{yy} ( {b}_{xx} {c}_{xy} - {b}_{xy} {c}_{xx} ) + {a}_{xy} ( {b}_{yy} {c}_{xx} - {b}_{xx} {c}_{yy} ) + {a}_{xx} ( {b}_{xy} {c}_{yy} - {b}_{yy} {c}_{xy} )} ) & ( 2 ) \\ K = Det ( κ ) = \frac{{( {α}_{∥} {α}_{⊥} )}^{2}}{{h}^{2}} \frac{{a}_{xy} ( {c}_{0} {b}_{xx} - {b}_{0} {c}_{xx} ) + {a}_{xx} ( {b}_{0} {c}_{xy} - {c}_{0} {b}_{xy} ) + {a}_{0} ( {b}_{xy} {c}_{xx} - {b}_{xx} {c}_{xy} )}{{a}_{yy} ( {b}_{xx} {c}_{xy} - {b}_{xy} {c}_{xx} ) + {a}_{xy} ( {b}_{yy} {c}_{xx} - {b}_{xx} {c}_{yy} ) + {a}_{xx} ( {b}_{xy} {c}_{yy} - {b}_{yy} {c}_{xy} )} \times \frac{{a}_{yy} ( {c}_{0} {b}_{xy} - {b}_{0} {c}_{xy} ) + {a}_{xy} ( {b}_{0} {c}_{yy} - {c}_{0} {b}_{yy} ) + {a}_{0} ( {b}_{yy} {c}_{xy} - {b}_{xy} {c}_{yy} )}{{a}_{yy} ( {b}_{xx} {c}_{xy} - {b}_{xy} {c}_{xx} ) + {a}_{xy} ( {b}_{yy} {c}_{xx} - {b}_{xx} {c}_{yy} ) + {a}_{xx} ( {b}_{xy} {c}_{yy} - {b}_{yy} {c}_{xy} )} - \frac{{( {α}_{∥} {α}_{⊥} )}^{2}}{{h}^{2}} {( \frac{{a}_{yy} ( {b}_{0} {c}_{xx} - {c}_{0} {b}_{xx} ) + {a}_{xx} ( {c}_{0} {b}_{yy} - {b}_{0} {c}_{yy} ) + {a}_{0} ( {b}_{xx} {c}_{yy} - {b}_{yy} {c}_{xx} )}{{a}_{yy} ( {b}_{xx} {c}_{xy} - {b}_{xy} {c}_{xx} ) + {a}_{xy} ( {b}_{yy} {c}_{xx} - {b}_{xx} {c}_{yy} ) + {a}_{xx} ( {b}_{xy} {c}_{yy} - {b}_{yy} {c}_{xy} )} )}^{2} , & ( 3 )\end{matrix}$$

where the sum and ratio of the layer thicknesses are m=a₁/a₂ and a₁+a₂=h and the coefficients are given by

$${α}_{0} ( {α}_{∥} - {α}_{⊥} ) {sin}^{2} ( θ ) , \\ {b}_{0} = - ( {α}_{∥} - {α}_{⊥} ) sin ( θ ) cos ( θ ) , \\ {c}_{0} = - {α}_{0}$$

$${α}_{xx} = \frac{{cos}^{4} ( θ ) + 2 m ( m ( 2 m + 3 ) + 2 )}{6 {m ( m + 1 )}^{2}} + \frac{{sin}^{4} ( θ ) ( 4 {cot}^{2} ( θ ) {E}_{x} + {E}_{⊥} )}{6 {m ( m + 1 )}^{2} {E}_{∥}} + \frac{{m}^{3} ( {E}_{∥} ( 4 {sin}^{4} ( θ ) {E}_{x} + {sin}^{2} ( 2 θ ) {E}_{⊥} ) + 4 {cos}^{2} ( θ ) {E}_{x} {E}_{⊥} )}{24 {( m + 1 )}^{2} {E}_{x} {E}_{⊥}}$$

$${b}_{xx} = \frac{sin ( 2 θ ) ( {E}_{∥} - {E}_{⊥} )}{48 {m ( m + 1 )}^{2} {E}_{x}} + \frac{h sin ( 4 θ ) ( {E}_{∥} - ( 4 {E}_{x} + {E}_{⊥} )}{96 {m ( m + 1 )}^{2} {E}_{x}} + \frac{{m}^{3} ( 8 sin ( θ ) {cos}^{3} ( θ ) {E}_{x} {E}_{⊥} - {E}_{∥} ( 8 {sin}^{3} ( θ ) cos ( θ ) {E}_{x} + sin ( 4 θ ) {E}_{⊥} ) )}{48 {( m + 1 )}^{2} {E}_{x} {E}_{⊥}}$$

$${c}_{xx} = \frac{{sin}^{2} ( 2 θ ) ( {E}_{x} ( ( {m}^{4} + 1 ) {E}_{∥} - 4 {E}_{x} ) + {E}_{⊥} ( {m}^{4} ( {E}_{x} - {E}_{∥} ) + {E}_{x} ) )}{24 {m ( m + 1 )}^{2} {E}_{x} {E}_{∥}}$$

$${a}_{xy} = - \frac{{m}^{4} sin ( 4 θ ) - 4 sin ( θ ) {cos}^{3} ( θ )}{12 {m ( m + 1 )}^{2}} + \frac{{E}_{x} ( 4 {m}^{4} sin ( θ ) {cos}^{3} ( θ ) - sin ( 4 θ ) )}{6 {m ( m + 1 )}^{2} {E}_{∥}} - \frac{2 {m}^{3} {sin}^{3} ( θ ) cos ( θ ) {E}_{x}}{3 {m ( m + 1 )}^{2} {E}_{⊥}} - \frac{sin ( 2 θ ) {sin}^{2} cos ( θ ) {E}_{⊥}}{6 {m ( m + 1 )}^{2} {E}_{∥}}$$

$${b}_{xy} = \frac{( {m}^{4} + 1 ) cos ( 4 θ ) + m ( m ( m + 2 ) ( m + 6 ) + 8 ) + 1}{12 {m ( m + 1 )}^{2}} + \frac{{sin}^{2} ( 2 θ ) ( {E}_{∥} + {E}_{⊥} ) ( 4 {m}^{4} {E}_{x}^{2} + {E}_{∥} + {E}_{⊥} )}{24 {m ( m + 1 )}^{2} {E}_{∥} {E}_{x} {E}_{⊥}}$$

$${c}_{xy} = \frac{sin ( 2 θ ) ( {m}^{4} ( cos ( 2 θ ) - {cos}^{2} ( θ ) )}{6 {m ( m + 1 )}^{2}} + \frac{2 {m}^{2} {sin}^{3} ( θ ) cos ( θ ) {E}_{x}}{3 {( m + 1 )}^{2} {E}_{∥}} + \frac{{E}_{x} ( sin ( 4 θ ) - 4 {m}^{4} sin ( θ ) {cos}^{3} ( θ ) ) + 2 {sin}^{3} ( θ ) cos ( θ ) {E}_{∥}}{6 {m ( m + 1 )}^{2}}$$

$${a}_{yy} = \frac{( {m}^{4} + 1 ) {sin}^{2} ( 2 θ )}{24 {m ( m + 1 )}^{2}} + \frac{( {m}^{4} + 1 ) {sin}^{2} ( 2 θ ) {E}_{⊥}}{24 {m ( m + 1 )}^{2} {E}_{∥}} - \frac{{E}_{⊥} ( {m}^{4} {sin}^{2} ( 2 θ ) {E}_{∥} - 2 {sin}^{2} ( θ ) {E}_{x} )}{24 {m ( m + 1 )}^{2} {E}_{∥} {E}_{x}}$$

$${b}_{yy} = \frac{sin ( 4 θ ) - 4 {m}^{4} sin ( θ ) {cos}^{3} ( θ )}{24 {m ( m + 1 )}^{2}} + \frac{{m}^{2} {sin}^{2} ( θ ) sin ( 2 θ ) {E}_{⊥}}{12 {( m + 1 )}^{2} {E}_{∥}} + \frac{sin ( 2 θ ) ( {E}_{⊥} ( ( 2 {m}^{4} - 1 ) cos ( 2 θ ) - 1 ) + 2 {sin}^{2} ( θ ) {E}_{∥} )}{48 {m ( m + 1 )}^{2} {E}_{x}}$$

$${c}_{yy} = \frac{( {m}^{4} + 1 ) {cos}^{4} ( θ ) + 2 m ( m ( 2 m + 3 ) + 2 )}{6 {m ( m + 1 )}^{2}} + \frac{{sin}^{4} ( θ ) {E}_{∥} + {sin}^{2} ( 2 θ ) {E}_{x}}{6 {m ( m + 1 )}^{2} {E}_{⊥}} + \frac{{m}^{3} {E}_{⊥} ( {sin}^{2} ( 2 θ ) {E}_{∥} + 4 {sin}^{4} ( θ ) {E}_{x} )}{24 {( m + 1 )}^{2} {E}_{∥} {E}_{x}}$$

Given the elastic constants of the hydrogel composite ink formulation, the longitudinal and transverse Youngs moduli are, in one example, E_{∥}˜40 kPa and E_{⊥}˜20 kPa and the shear modulus is Eₓ˜1/4(E_{∥}+E_{⊥})(1−v)˜15 kPa, assuming the Poisson ratio v=0, and the mean and Gaussian curvatures scale respectively as

$$H = {c}_{1} \frac{{α}_{∥} - α ⊥}{h} \frac{{sin}^{2} ( θ )}{{c}_{2} - {c}_{3} cos ( 2 θ ) + {m}^{4} cos ( 4 θ )}$$

$$and$$

$$K = - {c}_{4} \frac{{( {α}_{∥} - α ⊥ )}^{2}}{{h}^{2}} \frac{{sin}^{2} ( θ )}{{c}_{5} - {c}_{6} cos ( 2 θ ) + {m}^{4} cos ( 4 θ )}$$

where the cᵢ are given by:

c₁=144(m−1)m(m+1)³(m²+1)

c₂=32m⁸+288m⁷+944m⁶+1824m⁵+2275m⁴+1824m³+944m²+288m+32

c₃=4m(8m⁶+12m⁵+8m⁴+9m³+8m²+12m+8)

c₄=1152m²(m+1)⁴

c₅=32m⁸+288m⁷+944m⁶+1824m⁵+2275m⁴+1824m³+944m²+288m+32

c₆=4m(8m⁶+12m⁵+8m⁴+9m³+8m²+12m+8)

It is noted that real elastomers have a finite Poisson ratio, v˜0.3-0.5. The choice v=0, made here, allowed for analytic inversion of the aforementioned equations. This choice also eliminates the edge boundary layers that otherwise make the analysis significantly more complex. In practice, this approximation is believed to be reasonable as the primary source of curvature results from the difference in principal swelling directions.

The ratio of interlayer thicknesses is believed to be crucial to determining the sign and magnitude of the resulting curvature for these structures. As the deposition nozzle may not have a dynamically variable radius, an effective thickness based on variable interfilament spacing is invoked to achieve local gradients in curvature. Since each layer contains a fixed volume of the deposited ink, the effective thickness may be given by the volume of the deposited ink divided by the cross-sectional area. This approach is consistent with the resulting porous structures, as the curvature is slowly varying depending on the level of filament diameter and interfilament spacing. Therefore, such a continuum approximation appears to be valid.

B. Mathematically Solving the Inverse Problem:

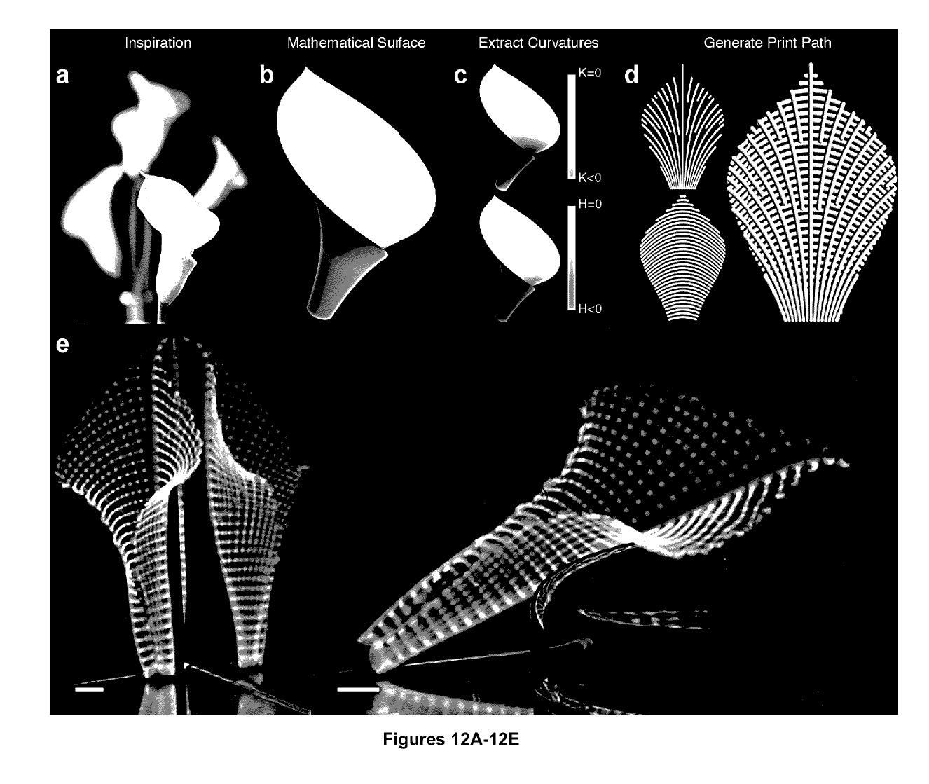

Referring to FIGS. 12A-12E, it is possible to begin with a desired 3D shape, such as the calla lily shown in FIG. 12A, provide a mathematical model of the 3D shape, and use the mathematical model to extract the desired curvatures and design a suitable print path and arrangement of filaments in each layer. In other words, solving the inverse problem uses the mean and Gaussian curvatures to determine the proper inputs for the printing process (e.g., the filament arrangement or print path, the height and thus nozzle size, and the overall boundary size and shape). The details of the inverse problem to find print paths for a given target surface are described in detail below.

In equilibrium, given κ, E, and h, Eqs. 1 yield ε^{s(1)} and ε^{s(2)}, solutions to the inverse problem. As an example of this, the mathematical model enables the translation of a complex three-dimensional surface (e.g., see FIG. 12B) described by the equation

$$r = \frac{1}{2} \{ {e}^{\frac{u / 2}{1 + u / 8}} cos ( v ) , {e}^{\frac{u / 2}{1 + u / 8}} sin ( v ) , \frac{2 u}{1 + u / 8} + \frac{16}{3} + \frac{v}{10} \} , \qquad ( 5 )$$

with uε(−4/3, 10) and vε(π, π), into a two-layered print path that can achieve this shape requiring only the local curvatures along with the swelling ratios and elastic constants of the hydrogel composite filaments.

Referring to FIGS. 12A and 12B, the curvatures of the calla lily surface, Eqn. 2, are given by

$$H = \frac{64000 {e}^{- \frac{4 u}{u + 8}}}{{( 100 {e}^{\frac{8 u}{u + 8}} + 1601 )}^{3 / 2}} \\ K = \frac{640400}{{( 100 {e}^{\frac{8 u}{u + 8}} + 1601 )}^{2}} \qquad ( 6 )$$

Since the curvatures are cylindrically symmetric, the calla lily may be treated “unrolled” to the plane, with the transform v→x/(2π), z→y, and treated in Monge gauge. With these as inputs, solving Eqns. 5 generates a thickness profile m(x,y) and an angular field Δθ(x,y). Using a known model by Aharoni, it is possible to calculate an initial line field θ₁(x,y) which dictates the geometry of the first layer. Using interfilament spacing as a proxy for thickness h, the streamlines of this field may be integrated to generate the print path for the first layer. The print path for the second layer may then be obtained by adding the two fields θ₁(x,y)+Δθ(x,y)=θ₂(x,y). The print paths for the lily are shown in FIG. 12D.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A method of 4D printing a hydrogel composite structure, the method comprising:
depositing a first layer of filaments on a substrate in a first predetermined arrangement, each filament comprising a hydrogel matrix and a plurality of anisotropic filler particles embedded therein;
depositing a second layer of the filaments in a second predetermined arrangement on the first layer, the filaments from the second layer contacting the filaments from the first layer at a number of contact points;
hydrating the first layer and the second layer, the filaments of the first and second layers swelling in size while remaining in contact at the contact points to form a curved three-dimensional hydrogel composite structure.

2. The method of claim 1, wherein depositing the first layer and the second layer comprises extruding a hydrogel composite ink formulation through a deposition nozzle to form the filaments while moving the deposition nozzle relative to the substrate.

3. The method of claim 1, wherein the anisotropic filler particles embedded in the hydrogel matrix are at least partially aligned with a longitudinal axis of each filament.

4. The method of claim 3, wherein the anisotropic filler particles are highly aligned with the longitudinal axis of each filament.

5. The method of claim 1, further comprising curing the hydrogel matrix to form a crosslinked hydrogel matrix.

6. The method of claim 5, wherein the curing comprises photopolymerization using UV light.

7. The method of claim 5, wherein the curing is carried out after depositing the filaments of both the first and the second layers.

8. The method of claim 1, wherein the swelling of each filament is greater along a transverse axis thereof than along the longitudinal axis.

9. The method of claim 8, wherein a ratio of the swelling along the transverse axis to the swelling along the longitudinal axis is at least about 2.

10. The method of claim 1, wherein the hydrating comprises exposing the first and second layers to water or an aqueous solution by dipping, immersion, or spraying.

11. The method of claim 1, wherein the hydrating is carried out at room temperature.

12. The method of claim 1, wherein the hydrogel matrix comprises a monomer comprising an acrylamide.

13. The method of claim 1, wherein the anisotropic filler particles comprise cellulose fibrils.

14. The method of claim 1, wherein the anisotropic filler particles have a length in the range of from about 5 nm to about 10 mm.

15. The method of claim 1, wherein the anisotropic filler particles are included in a hydrogel composite ink formulation employed for deposition at a concentration of from about 0.01 wt. % to about 10 wt. %.
